(19) United States
(12) Patent Application Publication
(10) Pub. No.: US 2021/0300545 A1
(43) Pub. Date: Sep. 30, 2021

(54) AERIAL VEHICLE

(71) Applicant: Animal Dynamics Limited, Oxford (GB)

(72) Inventors: Alexander COLTMAN, Oxford (GB); Will JOHNSON, Oxford (GB); Oliver HOBSON, Oxford (GB); Adrian THOMAS, Oxford (GB); Jorgen TVEIT, Oxford (GB)

(21) Appl. No.: 17/322,523

(22) Filed: May 17, 2021

Related U.S. Application Data
(63) Continuation of application No. PCT/GB2019/053307, filed on Nov. 22, 2019.

(30) Foreign Application Priority Data
Nov. 22, 2018 (GB) 1819006.6

(51) Int. Cl. B64C 31/036; B64D 17/02; B64D 17/80

(52) U.S. Cl. CPC B64C 31/036; B64D 17/80; B64D 17/025

(57) ABSTRACT

An aerial vehicle comprising: a source of thrust, for propelling the vehicle forwards; and a canopy attachment arrangement having at least one securement point for at least one line of a canopy securable to the vehicle in use for providing lift to the vehicle, wherein the canopy attachment arrangement is configured such that the at least one securement point is movable between a first position below the line of thrust and a second position above the line of thrust.

### CROSS-REFERENCE

This application is a Continuation of International Application No. PCT/GB2019/053307, filed Nov. 22, 2019, which claims the benefit of GB International Application No. GB 1819006.6, filed Nov. 22, 2018, both of which are incorporated herein by reference in their entirety.

### DESCRIPTION OF INVENTION

The present invention relates to an aerial vehicle. More specifically, the present invention relates to an aerial vehicle having an inflatable canopy and a source of thrust.

### BACKGROUND OF THE INVENTION

Powered air vehicles using soft wings made of fabric (e.g. a canopy/parachute), generally known as powered parachutes, are used for leisure activities and surveillance, and occasionally for air delivery. Such vehicles may also be referred to as motorised parachutes, paraplanes or PPCs, paramotor, powered paragliders or PPGs.

The low cost and high lift capability of these vehicles make them particularly suitable as delivery vehicles and their capability can be significantly enhanced by designing them to fly autonomously using a control and guidance system following a set of predetermined instructions and/or directed by a remote pilot.

The most significant challenge for users operating an autonomous aerial vehicle may occur when the vehicle is preparing for take-off. During take-off, the wing needs first to inflate and then to sit stably above the vehicle to ensure a successful and safe take-off.

To further explain the factors affecting such vehicles, an aerial vehicle 1 is shown schematically in FIG. 1. The aerial vehicle 1 comprises an airframe 2 (e.g. chassis) comprising an undercarriage 3. In the arrangement shown, the undercarriage 3 comprises three wheels 4 provided in a tricycle arrangement. Other forms of undercarriage 3, not necessarily including wheels 4, are also possible. The centre of gravity 5 of the aerial vehicle 1 is preferably arranged within the footprint of the undercarriage 3 such that the aerial vehicle 1 is stably supported by the undercarriage 3 when at rest. The aerial vehicle 1 further comprises a source of thrust 6. In the arrangement shown, the source of thrust 6 comprises an engine (not shown) and propeller 7. The propeller 7 is mounted on a hub 8. A guard arrangement 9 may be provided around the propeller 7 and/or engine to prevent injury to users and/or anything impacting the propeller 7 and/or engine, such as canopy support and/or control lines. The aerial vehicle 1 may further comprise a payload bay 100.

The aerial vehicle 1 further comprises a canopy 10 (not shown in FIGS. 1 to 4) which can be of conventional construction. A plurality of canopy lines 11 is secured between various points on the canopy 10 and the airframe 2 of the aerial vehicle 1. In FIGS. 1 to 3, only a single canopy line 11 is shown, to aid the illustration and to generally indicate the direction of the net force which is imparted by the canopy 10 on the airframe 2 of the aerial vehicle 1 in use. Any reference to a ‘canopy line 10’ herein may be seen as a reference to the canopy lines 10 collectively, as appropriate.

The canopy lines 11 are secured to at least one securement point 12 on the aerial vehicle 1. The canopy 10 can effectively pivot about the at least one securement point 12. So as to provide a stable aerial vehicle 1, there may be two securement points 12 separated from one another in a direction perpendicular to the longitudinal axis of the aerial vehicle 1. Half of the canopy lines 11 may be secured to a first securement point 12 and the other half of the canopy lines 11 may be secured to a second securement point 12. The canopy 10 may further comprise control lines (not shown), secured to other control mechanisms of the aerial vehicle 1. Any suitable number of securement points 12 may be used. There may be one securement point 12, or more than two securement points 12 provided, which may be arranged linearly or otherwise. Multiple securement points may be provided, distributed across two axes (e.g. a plane). Any other conventional features of a powered parachute arrangement may be adopted with the arrangements disclosed herein, as appropriate.

A powered parachute, of the type illustrated in the Figures, is similar to a paramotor, in that it combines an inflatable canopy with a source of thrust. Whereas a powered parachute provides an airframe having an undercarriage and an optional seat for a user, a paramotor comprises an airframe which is secured directly to a user's back. Nevertheless, the principles of use are the same and the skilled person will appreciate that the arrangements described herein may be applicable to paramotors as well as to powered parachutes. The term ‘aerial vehicle’ is used herein to encompass all such arrangements.

As indicated in FIG. 1 by the dotted line, the source of thrust 6 provides a thrust which has a line of thrust 15. The line of thrust 15 is substantially perpendicular to the plane in which the propeller 7 rotates. In the arrangement shown in FIG. 1, the line of thrust 15 is substantially parallel to the longitudinal axis of the aerial vehicle 1 and generally horizontal. However, the angle of the line of thrust 15 relative to the longitudinal axis of the vehicle 1 and/or horizontal may not be parallel (see FIGS. 6 and 7) and/or may be adjustable. The source of thrust 15 propels the vehicle 1 forwards.

As will be noted from FIG. 1, the securement point 12 for the canopy line 11 is below the line of thrust 15 of the source of thrust 6. A consequence of this arrangement is that, during take-off and during flight, any increase in thrust may cause the aerial vehicle 1 to pitch downwardly (‘nose down’). This is as a result of the moment arm created by the distance between the line of thrust 15 and the securement point 12. This may be an undesirable flight characteristic. During take-off this may cause the vehicle to unload the front wheels which may cause a steering input such that the vehicle cannot maintain a stable straight take-off run

FIG. 2 shows an alternative arrangement, in which the securement point 12 is provided at a point above the line of thrust 15. Consequently, the application of thrust during flight does not cause the aerial vehicle 1 to pitch downwardly. Instead, the aerial vehicle 1 may pitch upwardly (‘nose up’), or may unload the front wheels during the take-off run (“wheelie”), again preventing a stable straight take-off run

The distance between the securement point 12 and the line of thrust 15 may be configured to provide the desirable flying and take-off behaviour, which may be somewhere between the arrangements shown in FIGS. 1 and 2.

FIGS. 1 and 2 illustrate the effects of the arrangement of the canopy securement point 12 relative to the line of thrust 15, during flight.

Prior to take-off, the canopy 10 must first be inflated and rotated into a position substantially above the vehicle 1 so as to create lift. As the vehicle 1 is propelled forward by the source of thrust 6, the flow of air over the canopy 10 creates lift and causes the vehicle 1 to become airborne.

Initially, the uninflated canopy 10 is laid out behind the aerial vehicle 1, so as to be generally aligned with the longitudinal axis of the aerial vehicle 1. As the source of thrust 6 is initiated, the wash from the source of thrust 6 causes the canopy 10 to begin to inflate, and for the at least one canopy line 11 securing the canopy 10 to the aerial vehicle 1 to become taut. As the canopy 10 is further inflated and creates a pressurised wing, the canopy 10 starts to rise towards a position where it is generally over the aerial vehicle 1. The phase during which the canopy 10 rises from the ground to being generally above the vehicle 1 may be referred to as the “rotation” phase.

During the inflation of the canopy 10 and the initial phase of the rotation, any wind gusts may cause additional drag on the canopy 10, which may increase the force imparted by the canopy 10 on the airframe 2 through the canopy line(s) 11. This is illustrated in FIG. 3, where the canopy line(s) 11 is illustrated as being substantially parallel to the line of thrust 15. The moment arm between the canopy line(s) 11 and the centre of gravity 5 of the aerial vehicle 1 may cause the nose of the aerial vehicle 1 to lift upwards and for the aerial vehicle 1 potentially to tip backwards—particularly given the relatively short distance between the centre of gravity 5 and the rear wheels 4. In this situation, only the continued thrust provided by the source of thrust 6 may keep the aerial vehicle 1 generally upright. The instability of the vehicle 1 during canopy 10 inflation/rotation is undesirable.

In order to reduce the likelihood of the aerial vehicle 1 tipping backwards during the inflation/rotation stage, the securement point 12 may be lowered relative to the line of thrust 15 and/or centre of gravity 5 of the aerial vehicle 1. However, as described with regard to FIGS. 1 and 2, a lower securement point 12 then has a negative effect on the flight characteristics.

The present invention seeks to address at least one of the aforementioned problems.

### SUMMARY OF THE INVENTION

Accordingly, the present invention provides an aerial vehicle comprising:
a source of thrust, for propelling the vehicle forwards; and
a canopy attachment arrangement having at least one securement point for at least one line of a canopy securable to the vehicle in use for providing lift to the vehicle,
wherein the canopy attachment arrangement is configured such that the at least one securement point is movable between a first position below the line of thrust and a second position above the line of thrust.

In at least one embodiment, the source of thrust is fixed relative to the aerial vehicle. In at least one embodiment, the angle of the line of thrust relative to A chassis of the aerial vehicle when the securement point is at said first position is the same as the angle of the line of thrust relative to the chassis of the aerial vehicle when the securement point is at said second position.

In at least one embodiment, the canopy attachment arrangement is configured such that the at least one securement point is in the first position during the inflation of a canopy in use; and in the second position during flight.

In at least one embodiment, the canopy attachment arrangement is configured such that the at least one securement point is movable from the first position to the second position during a rotation phase of inflation of the canopy.

In at least one embodiment, the centre of gravity of the vehicle is substantially vertically below the second position.

In at least one embodiment, the canopy attachment arrangement is configured such that the distance between the first and second positions is adjustable.

In at least one embodiment, the canopy attachment arrangement is configured such that the respective distances between the first and second positions and the line of thrust are adjustable.

In at least one embodiment, there are two securement points.

In at least one embodiment, the canopy attachment arrangement is configured to bias the at least one securement point towards the first position.

In at least one embodiment, the canopy attachment arrangement is configured to move the at least one securement point from the first position to the second position when the angle of the at least one canopy line relative to the longitudinal axis of the vehicle exceeds a predetermined angle.

In at least one embodiment, the canopy attachment arrangement is configured to at least momentarily reduce the load on the canopy line when the at least one securement point moves from the first position to the second position.

In at least one embodiment, the canopy attachment arrangement is configured such that the at least one securement point may be selectively held at the first or second position, or at a predetermined point therebetween.

In at least one embodiment, the canopy attachment arrangement comprises a bar pivotably mounted to the vehicle and the at least one securement point is provided on the bar.

In at least one embodiment, the bar is substantially linear and arranged generally horizontally, and is pivotably mounted to the vehicle by at least one hinge member.

In at least one embodiment, the bar is substantially non-linear and is pivotably secured at either end to the vehicle.

In at least one embodiment, the bar is substantially arcuate.

In at least one embodiment, the bar is movable such that in the first position the at least one securement point is arranged rearwards of the source of thrust and in the second position the at least one securement point is arranged forwards of the source of thrust. In at least one embodiment, the source of thrust includes a propeller and the radius of the bar is greater than the radius of the propeller.

In at least one embodiment, the canopy attachment arrangement comprises at least one track mounted to the vehicle and at least one track follower retained for movement along the track, wherein the at least one securement point is provided by the at least one track follower.

In at least one embodiment, the at least one track is provided by one of a rail, slot, post or line.

In at least one embodiment, the track causes the at least one securement point to prescribe a path between the first and second positions which is non-linear.

In at least one embodiment, the canopy attachment arrangement comprises at least one key member tethered to the vehicle and rotatably retainable in a lock body mounted to the vehicle, wherein the key member provides the at least one securement point and is configured to be released from the lock body when the key member is at a predetermined angle relative to the lock body.

In at least one embodiment, the canopy attachment arrangement comprises a canopy support member pivotably mounted to the vehicle and providing the at least one securement point, and a tether secured between the vehicle and the canopy support member, wherein the at least one securement point is arranged at the first position when the tether is slack, and the second position when the tether is taut.

In at least one embodiment, the aerial vehicle further comprises an undercarriage.

In at least one embodiment, the aerial vehicle further comprises a canopy having an inflatable wing and a plurality of canopy lines attached thereto, wherein at least one of the canopy lines is secured to the at least one of the securement points.

### BRIEF DESCRIPTION OF THE DRAWINGS

Embodiments of the present invention will now be described, by way of non-limiting example only, with reference to the Figures in which;

FIG. 1 illustrates an aerial vehicle with a low canopy line securement point;

FIG. 2 illustrates an aerial vehicle with a high canopy line securement point;

FIG. 3 illustrates the configuration of the canopy line(s) of the aerial vehicle of FIG. 2 during canopy inflation/rotation;

FIG. 4 schematically illustrates a part of an aerial vehicle embodying the present invention;

FIG. 5 illustrates another aerial vehicle embodying the present invention;

FIGS. 6 and 7 show the aerial vehicle of FIG. 5 in first and second configurations;

FIG. 8 schematically illustrates another aerial vehicle embodying the present invention, comprising a track;

FIG. 9 schematically illustrates another aerial vehicle embodying the present invention, comprising another track;

FIG. 10 schematically illustrates another aerial vehicle embodying the present invention, comprising a key member;

FIG. 11 schematically illustrates another aerial vehicle embodying the present invention, comprising a tether; and

FIG. 12 schematically illustrates the angle between the tangent of the canopy attachment point and the canopy line, and the forces imparted on the canopy line, during operation.

### DETAILED DESCRIPTION OF THE DRAWINGS

The skilled person will appreciate that the terms ‘back’, ‘side’, ‘vertical’, ‘horizontal’, ‘left’, ‘right’, ‘upper’ and ‘lower’ may be used herein for convenience, to aid the explanation of the features of the vehicle. The terms are not to be seen as limiting. The skilled person will appreciate that if two elements are vertically aligned when the vehicle is at rest on the ground, they may not be so aligned in flight, due to the attitude, pitch and/or roll of the vehicle in flight.

Unless the context requires otherwise, when a first feature is described as being ‘in front of’ a second feature, this means that the first feature is closer to the nose/front of the vehicle than the second feature. The opposite applies to the term ‘behind’.

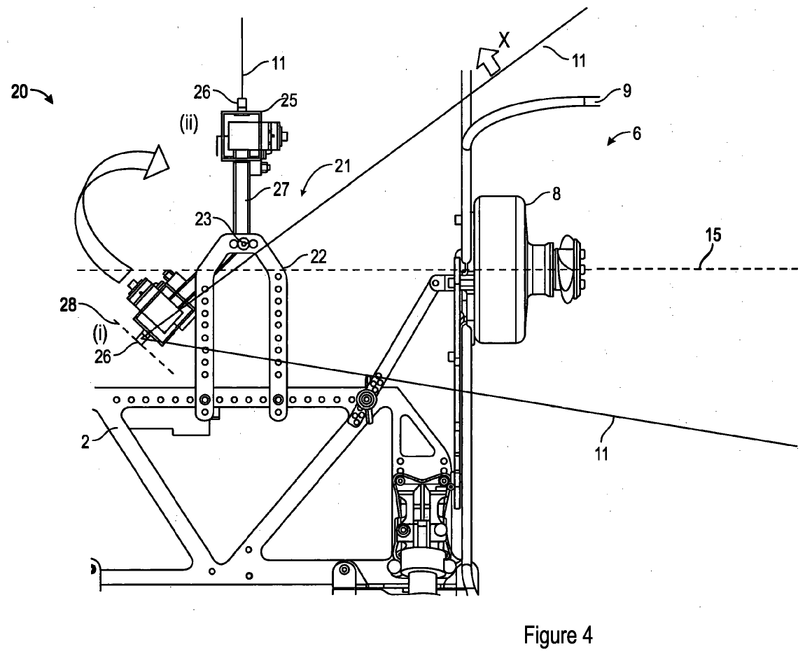

FIG. 4 shows a part of an aerial vehicle 20 embodying the present invention. Only part of the airframe 2 of the aerial vehicle 20 is shown. The rest of the airframe 2 may comprise an undercarriage 3 as illustrated in any of FIGS. 1 to 3 and 5 to 11. The features of the undercarriage 3 are not important to the invention. FIG. 4 also illustrates part (the propeller hub 8) of a source of thrust 6. The propellers 7 of the source of thrust 6 are not shown. As with all the embodiments disclosed herein, the precise form of the source of thrust 6 is not of relevance. The source of thrust 6 generates a thrust having a line of thrust 15 as indicated by the dotted line.

The aerial vehicle 20 shown in FIG. 4 further comprises a canopy attachment arrangement 21. The canopy attachment arrangement 21 comprises a mounting bracket 22 attached to the airframe 2. The mounting bracket 22 provides an anchor point 23 which is rigidly arranged relative to the airframe 2 of the aerial vehicle 20. Preferably, there are two mounting brackets 22 provided on either side (i.e. port and starboard) of the aerial vehicle 20. Due to the illustration in FIG. 4 being a side view, only the left (port) mounting bracket 22 is shown. The two mounting brackets 22 may be substantially identical or mirror images of one another.

The aerial vehicle 20 further comprises a support bar 25 which extends substantially parallel to the longitudinal axis of the aerial vehicle 20 and provides at least one securement point 26 for the canopy line(s). The axis of the support bar 25 is substantially perpendicular to, and offset from, the line of thrust 15. The canopy attachment arrangement 21 further comprises at least one hinge member 27. The hinge member(s) 27 spaces the support bar 25 from the anchor point 23 and allows the support bar 25 (and thus the at least one securement point 26) to pivot with respect to the anchor point 23 of mounting bracket 22.

In the schematic arrangement shown in FIG. 4, the canopy attachment arrangement 21 is illustrated both in a first (collapsed) configuration (i), wherein the hinge member 27 and support bar 25 have pivoted with respect to the anchor point 23 until the support bar 25 engages with the mounting bracket 22; and in a second (in flight) configuration (ii) in which the support bar 25 and hinge members 27 are arranged generally vertically above the anchor point 23 of the mounting bracket 22. Due to gravity, when there is no force provided on the support bar 25 by the canopy line(s) 11, the hinge member 27 and support bar 25 tend to rotate towards the first configuration (i) whereby the support bar 25 is arranged generally adjacent the mounting bracket 22. Further rotation is prevented by the support bar 25 and/or hinge member 27 impacting against the mounting bracket 22.

As with all embodiments herein, the canopy attachment arrangement 21 may be configured to constrain the securement point(s) 26 to movement only between predetermined first and second positions and/or to prescribe a predetermined path.

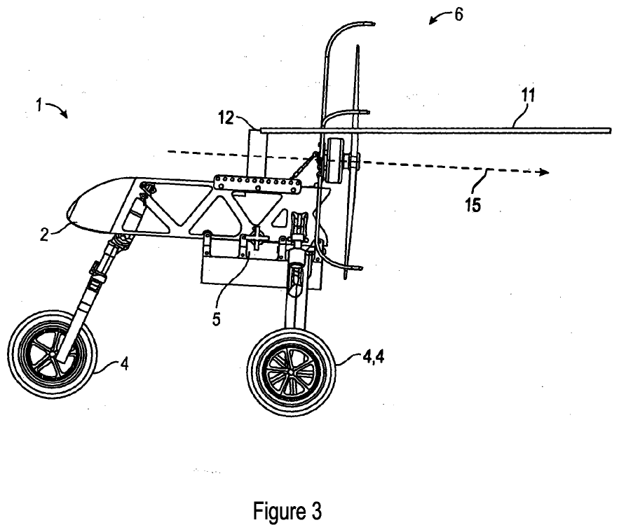

When the support bar 25 is in the “first position” (i), the securement point(s) 26 for the canopy line(s) 11 is arranged below the line of thrust 15. Consequently, the securement point 26 is closer to the centre of gravity. When the source of thrust 15 is initiated, the wash serves to inflate the canopy 10 and it begins to rotate. As the canopy 10 inflates and during the initial stage of rotation, the securement point 26 is still below the line of thrust 15, which serves to avoid, or at least reduce, the chances of the nose of the aerial vehicle 20 from lifting off the ground. Accordingly, during inflation and the initial stage of the rotation, the aerial vehicle 20 as illustrated in FIG. 4 may be more stable than the arrangement of FIG. 3.

Initially, before or during inflation, the canopy line 11 may be arranged as indicated by the line labelled A. As the canopy 10 is further inflated and goes through its rotation phase, the angle between the canopy lines 11 and longitudinal axis of the vehicle 20 increases. As illustrated in FIG. 4, by line B, there reaches a point where the anchor point 23 is almost in line with the canopy line(s) 11. As the canopy line(s) 11 moves past the anchor point 23, as indicated by the arrow X in FIG. 4, the forces imparted on the securement point 26 by the inflated canopy 10 serve to create an increasing moment arm about the anchor point 23, which causes the support bar 25 and hinge member 27 to rotate relative to the anchor point 23 (clockwise, when looking at FIG. 4). See arrow Y.

As the canopy line(s) 11 moves past the anchor point 23, the securement point 26 effectively moves towards the canopy 10. Consequently, there may be a drop in the forces being imparted by the canopy 10 on the securement point 26 through the canopy line(s) 11. In other words, the canopy line(s) 11 become ‘unloaded’. The arrangement provides an over-dead-centre arrangement which, momentarily at least, causes a reduction in the forces imparted by the canopy 10 on the securement point 26.

This ‘unloading’ of the canopy line may have the benefit of reducing the forces delivered by the canopy to the vehicle, which allows the vehicle to remain stable during this phase of the launch. Without this ‘unloading’ there may otherwise be a momentary increase in lift which could provide enough force to cause the vehicle to momentarily lift off and any asymmetry in the wing could roll the vehicle.

The ‘unloading’ may also have the benefit of reducing the aerodynamic forces applied by the vehicle through the canopy line to the canopy. With no forces applied through the canopy line, there is no force to continue to accelerate the canopy through the launch-arc (the arc the canopy follows as it goes from its position at rest on the ground to the flight position above the vehicle during the launch phase). If the reduction (unloading) of forces is correctly timed relative to the movement of the canopy through launch arc, then the canopy will stop at the designed position directly above the vehicle. The timing of the unloading event can be designed by changing the shape and dimensions of the over-dead-centre arrangement. Canopies of different design will have different optimum timings for the unloading in forces. Preferably, the canopy attachment arrangement is configurable so as to adjust and/or optimise the launch behaviour for a given wing.

At this point of unloading of the canopy line 11, with the canopy 10 still substantially inflated and the angle of the canopy line 11 in relation to the longitudinal axis of the vehicle 20 at or above a predetermined angle, and with the continued application of thrust, the drag caused by the canopy 10 will decrease and the lift created by the canopy 10 will increase. As further lift is generated the canopy lines 11 will be substantially vertical, as indicated by line C in FIG. 4.

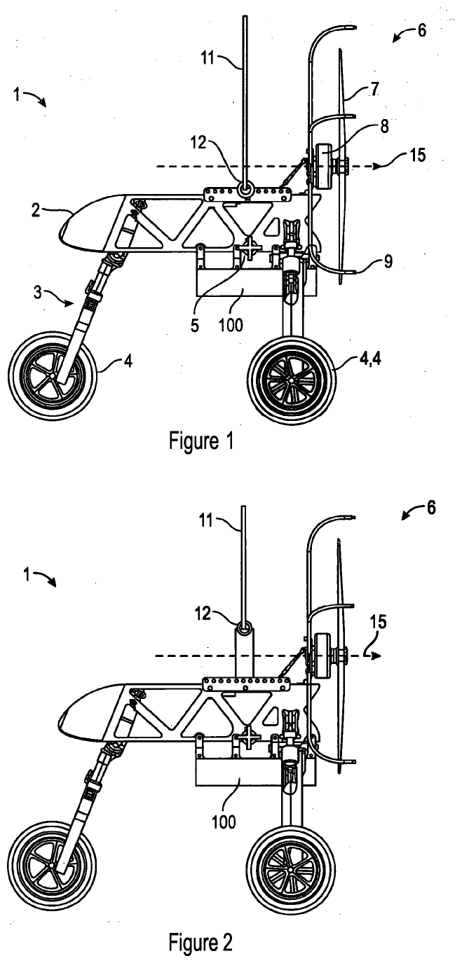

At this point, the canopy line 11, the securement point 26 and the anchor point 23 are substantially aligned with one another. The distance between the securement point 26 and the line of thrust 15 may be substantially the same as that of the arrangement shown in FIG. 2, which provides a stable flight characteristic.

Therefore, an aerial vehicle 20 embodying the present invention provides a canopy attachment arrangement 21 which allows for inflation of the canopy 10 whilst reducing the risk of instability of the aerial vehicle 20 and yet also provides an aerial vehicle 20 which is stable in flight.

The securement point 26 prescribes a path between the first position and the second position. Preferably, at least one point along the path, the angle between the tangent 28 of the path at that point and the canopy line 11 is acute. This has the effect of momentarily reducing the forces imparted by the canopy 10 on the securement point 26—it ‘unloads’ the canopy line.

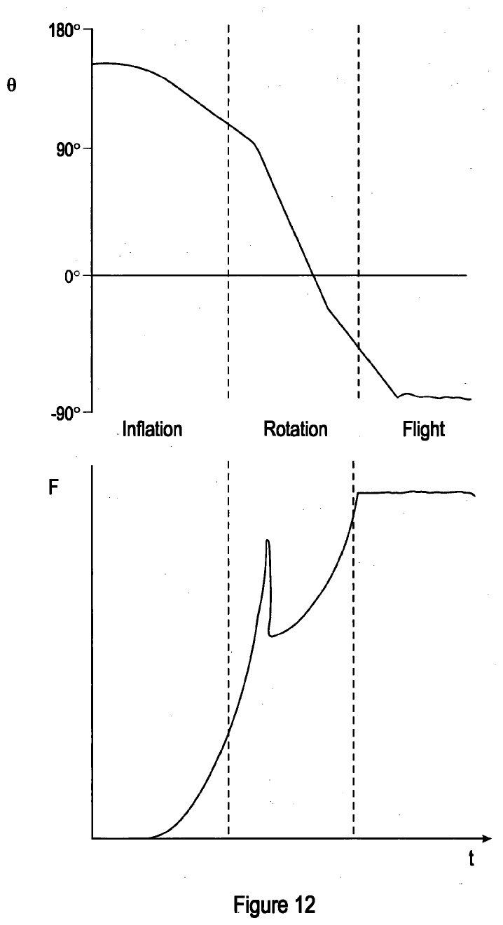

FIG. 12 schematically illustrates how the angle θ between the tangent 28 of the path of the securement point 26 and the canopy line 11 may change over time, during the inflation, rotation and flight phases. FIG. 12 also schematically illustrates how the forces imparted on the securement point 26 by the canopy 10 may vary during those phases.

Initially, during inflation, the angle θ may be around 130° (See line A in FIG. 4) and remain at that angle as the canopy 10 is inflated. There may be little or no force F imparted by the canopy 10 on the canopy line 11. When inflated, the canopy 10 will start to rotate and the force will increase. As it does so, the angle θ reduces. When the angle θ reaches around 90° (line B), the canopy attachment arrangement 21 will operate to move the securement point 26 from the first position to the second position. As it does so, the angle θ may drop dramatically. At the same time, the force imparted by the canopy 10 on the securement point will suddenly drop—the canopy line will be momentarily ‘unloaded’. As the canopy line 11 goes taut once more, the force rises again, as the canopy 10 rotates full into position and generates lift (line C).

With reference to FIG. 4, the support bar 25 and hinge member 27 may be pivoted towards the other direction before inflating the canopy 10. Such an arrangement will still position the at least one securement point 26 below the line of thrust 15 during inflation/rotation, and above during flight. However, the arrangement may not provide any momentary unloading of the canopy line(s) 11 during rotation. This is because there may always an obtuse angle between the tangent 28 of the path and the canopy line(s) 11.

With reference to FIG. 4, the length of the hinge member 27 may be adjustable. Alternatively or additionally, the distance between the securement point 26 and the anchor point 23 may be adjustable. Additionally or alternatively, the distance between the anchor point 23 and the centre of gravity 5 of the aerial vehicle may be adjustable. Additionally or alternatively, the distance between the anchor point 23 and the undercarriage/ground 3 may be adjustable. The securement point 26 may be substantially vertically above the centre of gravity 5 of the aerial vehicle 20. In the arrangement shown, the first position of the securement point 26 is forward of the second securement point.

With reference to FIG. 4, it may be said that the canopy attachment 21 arrangement is biased into the first position, owing to gravity. That is to say that when no other forces are imparted on the canopy attachment arrangement 21, gravity causes the support bar 25 and hinge member 27 to hinge downwardly with respect to the mounting bracket 22. A spring member may additionally be provided to bias the canopy attachment arrangement 21 to the first position. The canopy attachment arrangement 21 may be configured such that the at least one securement point 26 may be selectively held at the first or second position, or at a predetermined point therebetween. For example, when the aerial vehicle 20 is in flight, the canopy attachment arrangement 21 may be configured such that the securement point 26 is locked in the second position. Movement between the first and second positions may be purely passive, as described above, or at least partially active. By “active” is meant that the rotation of the hinge member 27 may be effected by a motor or other drive means beyond simply an imbalance in the system of forces being applied to the arrangement by the canopy 10.

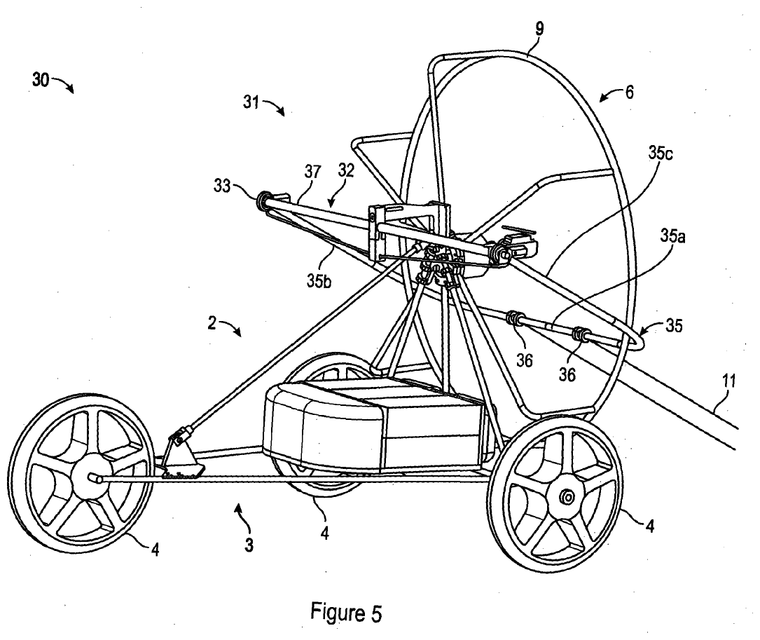

FIGS. 5 to 7 illustrate another aerial vehicle 30 embodying the present invention. In this embodiment, the canopy attachment arrangement 31 comprises a bar 35. As compared to the linear support bar 25 as shown in FIG. 4, the bar 35 of the canopy attachment arrangement 31 shown in FIGS. 5 to 7 is non-linear. The bar 35 comprises linear central 35a and distal end 35b, 35c portions connected to one another by curved portions, such that central portion 35a is substantially perpendicular to the distal end portions 35b, 35c.

In another embodiment, the bar is substantially arcuate. The arcuate bar may have a substantially constant radius of curvature. The arcuate bar may be parabolic.

In the arrangement shown in FIG. 5, the bar 35 is pivotably attached at either end to a mounting structure 32 of the airframe. The mounting structure may comprise a support beam 37 which is held rigidly relative to the airframe 2, providing two anchor points 33. Two canopy line securement points 36 are provided on the bar 35, spaced from one another. In the arrangement shown, the canopy line securement points 36 are arranged towards the ends of the linear central portion 35a of the bar 35.

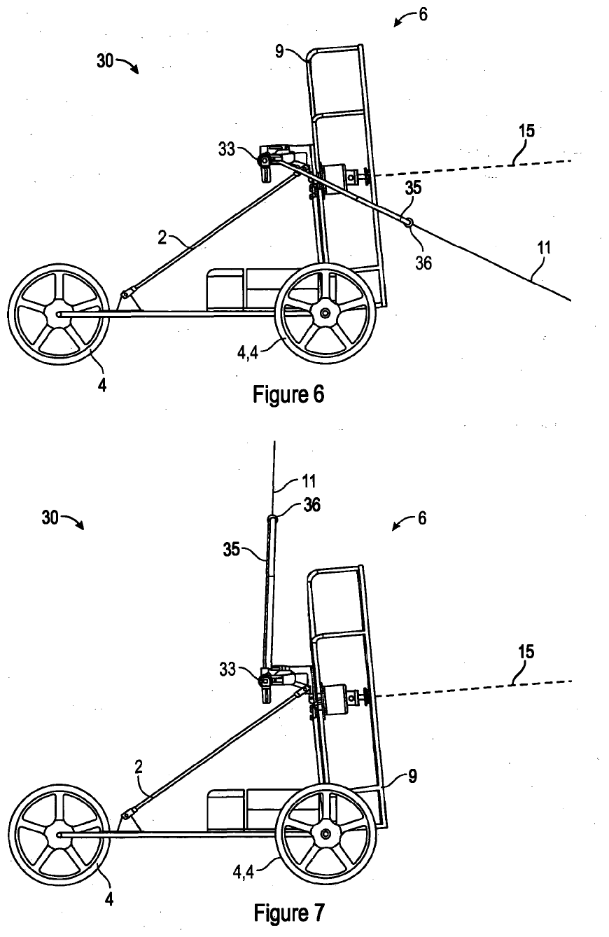

FIGS. 5 and 6 illustrates the aerial vehicle 30 prior to, or during, the initial inflation stage of the canopy 10. As with the arrangement shown in FIG. 4, when the canopy 10 is inflated and starts to rotate, the angle between the canopy line(s) 11 and the longitudinal axis of the vehicle 30 starts to increase which, in turn, causes the bar 35 to rotate upwardly (counter-clockwise in FIG. 6).

In the arrangement shown, the source of thrust 6 includes a propeller (not shown) and a propeller guard 9. The propeller guard 9 may comprise only the framework as shown. An additional guard material (such as a wire mesh) may additionally be provided.

In at least one embodiment, the bar 35 is configured such that the bar can pivot between the configurations illustrated in FIGS. 6 and 7 without impacting the source of thrust 6 (i.e. propeller and/or guard 9). A benefit of the arrangement is that the propeller guard 9 may not be needed at all, because the use of the pivoting bar 35 may serve to keep the canopy line(s) 11 away from the source of thrust 6 during the inflation/rotation phases. This may save mass. If the canopy lines 11 were otherwise secured to securement points 36 forward of the propeller arrangement (such as in FIGS. 1 and 2) and spaced by the distance shown in FIG. 5, they could snag with and get caught by the propeller. Even if a propeller guard 9 is present, the canopy lines 11 may rub against the guard 9 and/or get snagged.

The arrangement of the canopy attachment arrangement 31 shown in FIG. 5 conveniently allows for the securement point(s) 36 for the canopy line(s) 11 to be arranged at the ideal spacing regardless of the diameter of the propeller or the existence of a propeller guard 9.

As shown in FIG. 7, once the canopy 10 has rotated, the canopy line(s) 11 are arranged substantially vertically above the aerial vehicle 30. As the canopy 10 inflates and subsequently rotates, the predetermined securement points 36 prescribe an arcuate path between the first and second positions.

With reference to FIG. 5, it will be noted that the first position of the securement points 36 is behind the source of thrust 6. That is to say that the at least one securement point 36 is provided at a point between the source of thrust 6 and the canopy 10. In the second position of the securement point 36 of the arrangement shown in FIG. 5, they are provided forwards of the source of thrust 6.

Alternatively, rather than starting to inflate the canopy 10 when the bar 35 is in the configuration shown in FIG. 6 (behind the source of thrust 6), the bar 35 may instead be rotated to rest on the airframe 2 (forwards of the source of thrust 6). Although this arrangement may increase the chance of the canopy lines 11 interfering with the propeller/guard 9 during inflation and rotation, it operates in substantially the same way as the arrangement of FIG. 4. That it is to say, when the canopy line(s) 11 moves past the anchor point 33, it creates a moment arm which causes the bar 35 to rotate about the anchor point 33. As it does so, as the securement point 36 effectively moves towards the direction of the canopy 10 and there may be a drop in the forces being imparted by the canopy 10 on the securement points 36 through the canopy line(s) 11.

Preferably, the support beam 37 in the arrangement shown in FIG. 5 is at least equal to or longer than the diameter of the source of thrust 6 (e.g. the guard 9) propeller and/or propeller. The distance between the anchor points 33 is preferably equal to or greater than the diameter of the propeller and/or propeller casing 9.

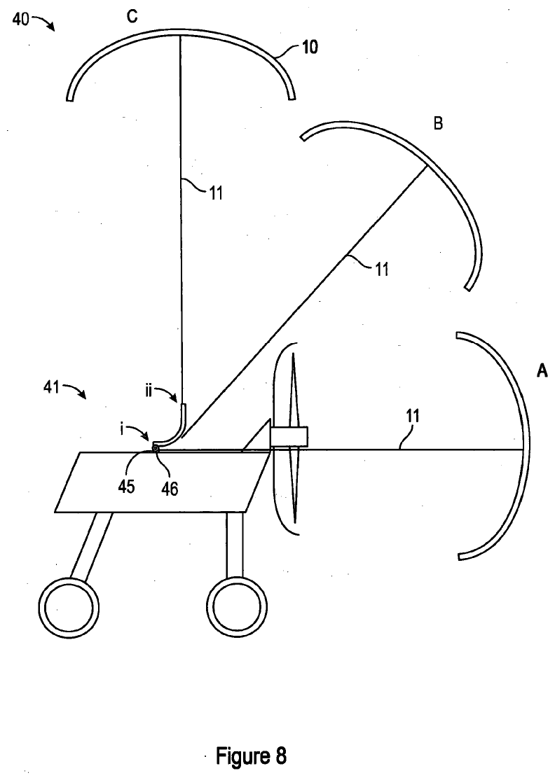

FIG. 8 illustrates another aerial vehicle 40 embodying the present invention, in which the canopy attachment arrangement 41 comprises a track 42 mounted to the vehicle 40 and at least one track follower 45 retained for movement along the track 42. The track follower 45 provides the at least one securement point 46 for the at least one canopy line 11. A bar may be connected to the track follower 45, which bar provides two spaced apart securement points 46. Alternatively, there may be two tracks 42 mounted at spaced apart locations, each with a separate track follower 45. Each track follower 45 may provide one of two securement points 46, to which half of the canopy lines 11 is attached. As noted above, there may be one, or more than two securement points 46. A bar may be connected between the two track followers 45.

The arrangement shown in FIG. 8 schematically illustrates the inflation A, rotation B and flight C positions of the canopy.

The track 42 is configured such that the second position (ii) is higher than and behind the first position (i). The increasing force imparted on the securement point 46 by the drag of the canopy 10, in combination with the angle of the canopy line(s) 11 relative to the longitudinal axis of the vehicle 40 causes the track follower 45 to ride along the track 42. A clutch or similar mechanism may be provided to selectively lock the track follower 45 at a predetermined point along the track 42. The friction between the track 42 and track follower 45 may be preconfigured and/or adjustable.

Owing to the shape of the track 42, as the canopy 10 transitions through the rotation phase B, and the track follower 45 rides along the track 42, the arrangement may serve to momentarily unload the canopy lines 11, as described above.

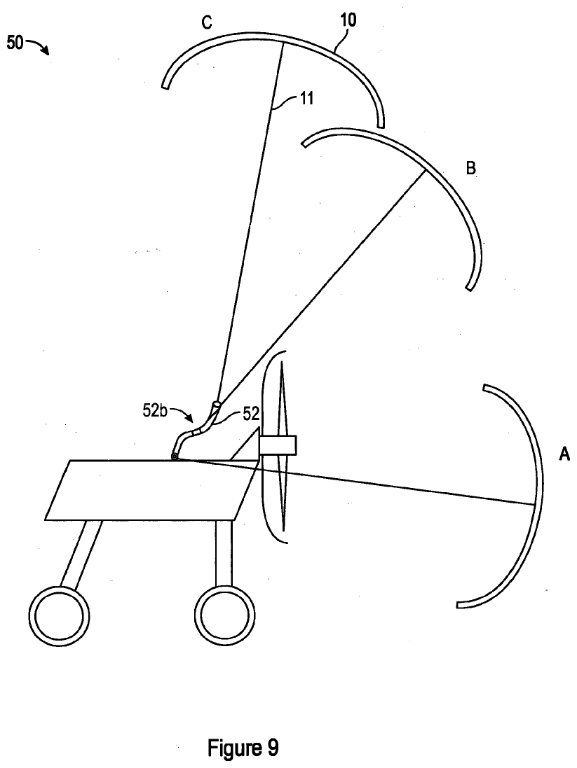

FIG. 9 illustrates an alternative embodiment of a track 52. Like the track 42 shown in FIG. 8, the track 52 in FIG. 9 is non-linear, Rather than being arcuate, the track 52 in the arrangement of FIG. 9 follows a more complex path. The path is generally S-shaped. The shape of the track 52 may be configured such that the force imparted by the canopy 10 on the securement point 56 follows a predetermined pattern over time. The central section 52b of the track 52 of the arrangement in FIG. 9 may be linear and arranged so as to be substantially co-axial with the canopy line(s) 11 at the point at which momentary unloading of the canopy lines is required. The track in FIG. 9 may allow more rapid unloading of the canopy lines than the arrangement of FIG. 8.

Although the arrangements 40, 50 of FIGS. 8 and 9 schematically illustrate a track 42, 52, corresponding arrangements are possible. For example, the track may comprise a rail on which a carriage is retained. Alternatively, the track may comprise a slot into which a cam follower is inserted and slidably retained. Alternatively, the track may be provided by a post. The post may be linear or non-linear. A collar providing the securement point(s) may be retained around the post and moveable along the length of the post. The post may be arranged subsequently perpendicularly to the longitudinal axis of the vehicle, or at an angle.

Alternatively, the track may be provided by a flexible line and a track follower is arranged on the line for movement between first and second positions, similar to a traveller system for use in yachts, for example the traveller system provided by Harken Inc of Wisconsin, USA.

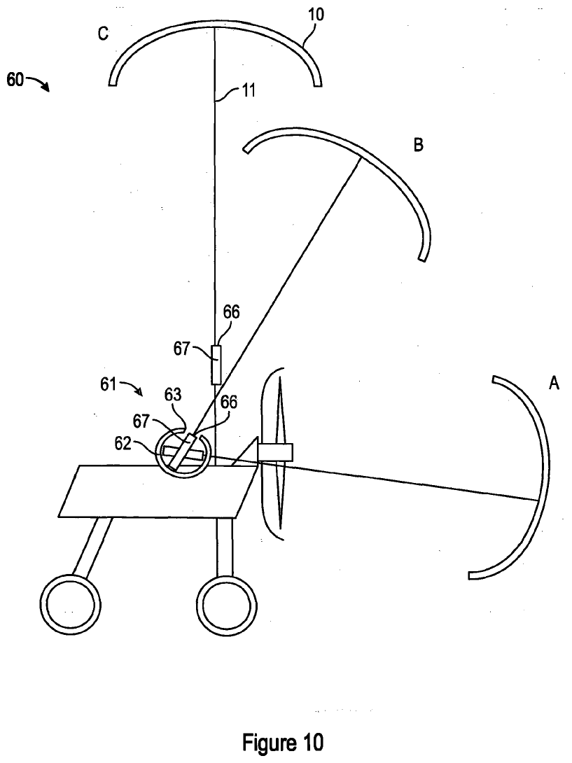

FIG. 10 schematically illustrates a canopy attachment arrangement 61 of an aerial vehicle 60 according to another embodiment of the present invention. The canopy attachment arrangement 61 comprises a key member 67 which is tethered to the vehicle 60 and rotatably retainable in a lock body 62. The key member 67 may be elongate and the lock body 62 may comprise a substantially cylindrical tube having an access aperture 63. The length of the elongate bar 67 may be substantially equal to the inner diameter of the tube 62. As shown schematically in FIG. 10, the key member 67 is attached to the canopy line(s) 11 such that the axis of the key member 67 is generally co-axial with the canopy line(s) 11.

Initially, during inflation (A), the key member 67 is held in the lock member 62. As the canopy line(s) 11 rotate, causing a corresponding rotation of the key member 67, the key member 67 will reach a point (B) where the key member 67 is able to escape through an aperture 63 (e.g. slot) in the lock body 62. The relative angle of aperture 63 in the lock body 62 may be configured such that the key member 67 is able to escape from the lock body 62 at the point (B) at which momentary unloading of the canopy line(s) is desired. The key member 67 is tethered to the airframe 2 of the vehicle 60 such that, when it is no longer held within the lock body 62, the key member 67 (and thus the securement point 66 provided by it) is held above the lock body 62 in a second position.

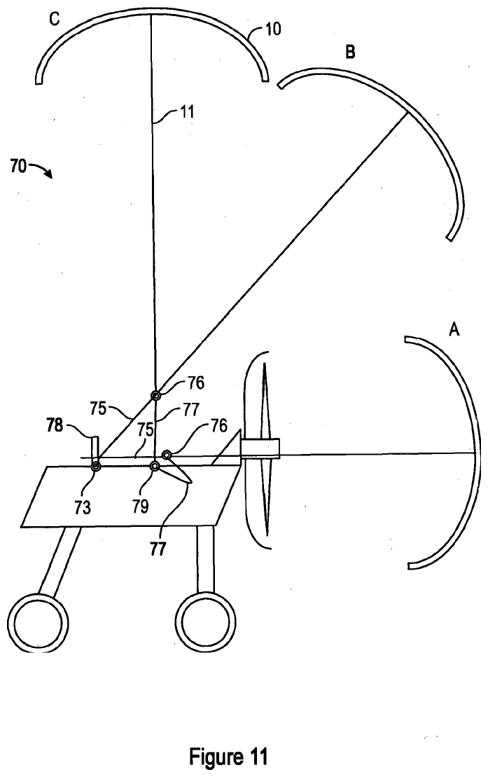

FIG. 11 shows a canopy attachment arrangement 71 according to another embodiment of the present invention. Here, the canopy attachment arrangement 71 comprises a canopy support member 75 which is pivotably mounted to the vehicle 70 and provides the at least one securement point 76 at a distal end thereof. Furthermore, the canopy attachment arrangement 71 comprises a tether 77 secured between the vehicle 70 and the canopy support member 75. Preferably, the points 73, 79 of the vehicle 70 to which the support member 75 and tether 77 are secured are spaced from one another, along the longitudinal axis of the vehicle 70. The tether 77 is flexible. The canopy support member 75 may be substantially rigid.

When the tether 77 is slack, the securement point 76 at the end of the canopy support member 75 is in a first position, as illustrated by A in FIG. 11. When the canopy 10 has inflated and at least partially rotated (B), the system of forces cause the canopy support member 75 to rotate upwardly, such that the securement point 76 moves upwardly. The canopy support member 75 continues to rotate until the tether 77 becomes taut, as shown.

At this point, further rotation of the canopy support member 75 is prevented. When the tether 77 is taut, the securement point 76 is in a known, second, position which is above the first position. The canopy can then further rotate (C) about the securement point 76 into a flight/lift position.

In one embodiment, the canopy support member 75 may be flexible, preferably comprising a tether.

A post 78 may further be associated with the anchor point 73 of the canopy support member 75. During the initial phases of inflation and rotation, the canopy support member 75 may be engaged with (e.g. wrapped around) the post 78. When the canopy line 11 reaches a predetermined angle, the canopy support member 75 may be released from the post 78, having the effect of causing a momentary unloading of the canopy line 11, as discussed above.

For the avoidance of doubt, FIG. 11 is a compiled schematic illustration of various phases of the vehicle 70. As the skilled person would appreciate, there is only a single canopy support member 75, single tether 77 and single (group of) canopy line 11, despite the figure appearing to suggest there are multiple ones of those. The same applies to the other figures showing the various phases.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

What is claimed is:

1. An aerial vehicle comprising:
a source of thrust, for propelling the vehicle forwards; and
a canopy attachment arrangement having at least one securement point for at least one line of a canopy securable to the vehicle in use for providing lift to the vehicle,
wherein the canopy attachment arrangement is configured such that the at least one securement point is movable between a first position below the line of thrust and a second position above the line of thrust.

2. An aerial vehicle according to claim 1, wherein the canopy attachment arrangement is configured such that the at least one securement point is in the first position during the inflation of a canopy in use; and in the second position during flight.

3. An aerial vehicle according to claim 1, wherein the canopy attachment arrangement is configured such that the at least one securement point is movable from the first position to the second position during a rotation phase of inflation of the canopy.

4. An aerial vehicle according to claim 1, wherein the centre of gravity of the vehicle is substantially vertically below the second position.

5. An aerial vehicle according to claim 1, wherein the canopy attachment arrangement is configured such that the distance between the first and second positions is adjustable.

6. An aerial vehicle according to claim 1, wherein the canopy attachment arrangement is configured such that the respective distances between the first and second positions and the line of thrust are adjustable.

7. An aerial vehicle according to claim 1, wherein there are two securement points.

8. An aerial vehicle according to claim 1, wherein the canopy attachment arrangement is configured to bias the at least one securement point towards the first position.

9. An aerial vehicle according to claim 1, wherein the canopy attachment arrangement is configured to move the at least one securement point from the first position to the second position when the angle of the at least one canopy line relative to the longitudinal axis of the vehicle exceeds a predetermined angle.

10. An aerial vehicle according to claim 1, wherein the canopy attachment arrangement is configured to at least momentarily reduce the load on the canopy line when the at least one securement point moves from the first position to the second position.

11. An aerial vehicle according to claim 1, wherein the canopy attachment arrangement is configured such that the at least one securement point may be selectively held at the first or second position, or at a predetermined point therebetween.

12. An aerial vehicle according to claim 1, wherein the canopy attachment arrangement comprises a bar pivotably mounted to the vehicle and the at least one securement point is provided on the bar.

13. An aerial vehicle according to claim 12, wherein the bar is substantially linear and arranged generally horizontally and is pivotably mounted to the vehicle by at least one hinge member.

14. An aerial vehicle according to claim 12, wherein the bar is substantially non-linear and is pivotably secured at either end to the vehicle.

15. An aerial vehicle according to claim 14, wherein the bar is movable such that in the first position the at least one securement point is arranged rearwards of the source of thrust and in the second position the at least one securement point is arranged forwards of the source of thrust.

16. An aerial vehicle according to claim 14 wherein the source of thrust includes a propeller and the radius of the bar is greater than the radius of the propeller.

17. An aerial vehicle according to claim 1, wherein the canopy attachment arrangement comprises at least one track mounted to the vehicle and at least one track follower retained for movement along the track, wherein the at least one securement point is provided by the at least one track follower, and optionally wherein the track causes the at least one securement point to prescribe a path between the first and second positions which is non-linear.

18. An aerial vehicle according to claim 1, wherein the canopy attachment arrangement comprises at least one key member tethered to the vehicle and rotatably retainable in a lock body mounted to the vehicle, wherein the key member provides the at least one securement point and is configured to be released from the lock body when the key member is at a predetermined angle relative to the lock body.

19. An aerial vehicle according to claim 1, wherein the canopy attachment arrangement comprises a canopy support member pivotably mounted to the vehicle and providing the at least one securement point, and a tether secured between the vehicle and the canopy support member, wherein the at least one securement point is arranged at the first position when the tether is slack, and the second position when the tether is taut.

20. An aerial vehicle according to claim 1, further comprising a canopy having an inflatable wing and a plurality of canopy lines attached thereto, wherein at least one of the canopy lines is secured to the at least one of the securement points.
